(19) United States
(12) Patent Application Publication
(10) Pub. No.: US 2026/0326414 A1
(43) Pub. Date: Oct. 22, 2026

(54) COMPOSITE LAMINATE BUILDING MATERIAL

(71) Applicant: Owens Corning Intellectual Capital, LLC, Toledo, OH (US)

(72) Inventor: Shane Polen, Columbus, OH (US)

(21) Appl. No.: 19/560,446

(22) Filed: Mar. 9, 2026

Related U.S. Application Data
(60) Provisional application No. 63/785,690, filed on Apr. 9, 2025.

(51) Int. Cl. B32B 7/03; B32B 5/02; B32B 27/08; B32B 27/32; E04D 11/02

(52) U.S. Cl. CPC B32B 7/03; B32B 5/02; B32B 27/08; B32B 27/32; E04D 11/02; B32B 2250/05; B32B 2262/101; B32B 2307/558; B32B 2307/718; B32B 2307/7376; B32B 2419/06

(57) ABSTRACT

A composite laminate is formed from alternating layers of a fiber-reinforced polymeric sheet, wherein adjacent layers of the sheet differ in orientation by approximately 90° (i.e., are oriented orthogonal to one another). The composite laminate includes multiple plies of the sheet. The composite laminate is suitable for use as a coverboard material on low-slope roofs, as a building panel, and as a rollable facing material.

### CROSS-REFERENCE TO RELATED APPLICATIONS

This application claims priority to and any benefit of U.S. Provisional Application No. 63/785,690, filed Apr. 9, 2025, the content of which is incorporated herein by reference in its entirety.

### FIELD

The inventive concepts generally relate to composite laminates and, more specifically, to a composite laminate suitable for use as a roofing coverboard, a building panel, and/or a rollable facing material.

### BACKGROUND

A conventional low-slope (i.e., relatively flat) roof typically has many materials positioned and installed on top of the roof deck. One such roof covering assembly/installation 100 will be described with reference to FIGS. 1A-1D. The roof deck 102 itself is often made of wood, concrete, or metal, such as the corrugated steel roof deck shown in FIG. 1A. Above the flat roof deck 102, one or more layers of an insulation material 104 are provided. The insulation material 104 is often rigid foam (e.g., XPS, polyiso) boards. The insulation material 104 may include a facing material (e.g., paper, fiberglass) on either or both sides thereof. A coverboard material 106 is often placed above the insulation. The coverboard material 106 provides a substrate that can be walked on without damaging the underlying layers, in particular, the insulation material 104. Thus, the coverboard material 106 generally serves to extend the serviceable life of the roof covering assembly 100, as well as providing a walkable substrate. Conventional coverboard materials 106 are typically rigid boards made of gypsum or a high-density (HD) polyiso material. Finally, a weather resistant membrane 108 is placed above the coverboard material 106. As shown in FIG. 1B, the layers 104, 106, and 108 define the installation thickness Iₜ of the roof covering assembly 100.

The roof covering assembly 100 can be joined together and secured to the roof deck 102 in many different ways, typically using one or more adhesive materials 120 and/or mechanical fasteners 122. Several representative installation approaches are shown in FIGS. 1C-1D.

Conventional coverboards have several drawbacks, such as (1) being unable to be rolled given their rigid construction; (2) having relatively poor impact strength (N); and (3) having relatively limited dimensions (width×length), with 4 feet by 8 feet and 4 feet by 4 feet being common board sizes.

Accordingly, a new and improved coverboard material is contemplated. The new material may find other applications in the building materials space, such as a wall or ceiling panel and as a rollable facing material for reinforcing or otherwise enhancing other substrates.

### SUMMARY

The general inventive concepts relate to a composite laminate material that is suitable for use in forming a coverboard, a building panel, and/or a facing material.

In one exemplary embodiment, a composite laminate for use as a coverboard installed above a roof deck is provided. The composite laminate comprises a plurality of polymeric sheets, each polymeric sheet defining a layer of the composite laminate and comprising a plurality of reinforcing fibers; wherein the polymeric sheets include a first polymeric sheet positioned so that the reinforcing fibers of the first polymeric sheet are oriented in a first direction; wherein the polymeric sheets include a second polymeric sheet positioned so that the reinforcing fibers of the second polymeric sheet are oriented in a second direction; and wherein the layer defined by the first polymeric sheet is adjacent to the layer defined by the second polymeric sheet.

In some exemplary embodiments, the first direction differs from the second direction by 85° to 95°.

In some exemplary embodiments, the first direction is the same as the second direction.

In some exemplary embodiments, the first direction is orthogonal to the second direction.

In some exemplary embodiments, the first direction corresponds to the machine direction of the first polymeric sheet. In some exemplary embodiments, the second direction corresponds to the cross direction of the first polymeric sheet.

In some exemplary embodiments, wherein at least one of the first polymeric sheet and the second polymeric sheet comprises about 10% to about 90% of a polymeric material and about 90% to about 10% of the reinforcing fibers. In some exemplary embodiments, at least one of the first polymeric sheet and the second polymeric sheet comprises about 20% to about 80% of a polymeric material and about 80% to about 20% of the reinforcing fibers. In some exemplary embodiments, at least one of the first polymeric sheet and the second polymeric sheet comprises about 40% to about 60% of a polymeric material and about 60% to about 40% of the reinforcing fibers.

In some exemplary embodiments, the composite laminate comprises from two to ten layers. In some exemplary embodiments, the composite laminate comprises at least three layers. In some exemplary embodiments, the composite laminate comprises at least six layers. In some exemplary embodiments, the composite laminate comprises at least nine layers. In some exemplary embodiments, the composite laminate comprises at least twelve layers. In some exemplary embodiments, the composite laminate includes 15-18 layers. In some exemplary embodiments, the composite laminate comprises up to about 40 layers.

In some exemplary embodiments, the composite laminate has a width greater than 4 feet. In some exemplary embodiments, the composite laminate has a width greater than 8 feet. In some exemplary embodiments, the composite laminate has a width in the range of about 7 feet to about 10 feet. In some exemplary embodiments, the composite laminate has a width of about 9 feet. In some exemplary embodiments, the composite laminate has a width of at least 10 feet.

In some exemplary embodiments, the composite laminate has a length greater than 16 feet. In some exemplary embodiments, the composite laminate has a length of at least 20 feet. In some exemplary embodiments, the composite laminate has a length of at least 40 feet. In some exemplary embodiments, the composite laminate has a length of at least 60 feet. In some exemplary embodiments, the composite laminate has a length of at least 80 feet. In some exemplary embodiments, the composite laminate has a length of at least 100 feet. In some exemplary embodiments, the composite laminate has a length of at least 500 feet. In some exemplary embodiments, the composite laminate has a length of at least 1,000 feet.

In some exemplary embodiments, the composite laminate has a thickness of less than ½ inch. In some exemplary embodiments, the composite laminate has a thickness equal to or less than ⅛ inch. In some exemplary embodiments, the composite laminate has a thickness of about ⅛ inch.

In some exemplary embodiments, the composite laminate has a width greater than 8 feet, a length greater than 50 feet, and a thickness of less than ½ inch.

In some exemplary embodiments, the composite laminate has a width of about 9 feet, a length of at least 80 feet, and a thickness of about ⅛ inch.

In some exemplary embodiments, the composite laminate has a weight of less than 2 lbs/ft². In some exemplary embodiments, the composite laminate has a weight of less than 1.8 lbs/ft². In some exemplary embodiments, the composite laminate has a weight of less than 1.6 lbs/ft². In some exemplary embodiments, the composite laminate has a weight of less than 1 lb/ft².

In some exemplary embodiments, the a facing material is affixed to at least one face of the composite laminate.

In some exemplary embodiments, the reinforcing fibers are glass fibers. In some exemplary embodiments, the glass fibers are made of E-CR glass.

In some exemplary embodiments, the composite laminate has an impact strength of at least 1,500 N. In some exemplary embodiments, the composite laminate has an impact strength of at least 2,000 N. In some exemplary embodiments, the composite laminate has an impact strength of at least 2,500 N. In some exemplary embodiments, the composite laminate has an impact strength of at least 3,000 N.

In some exemplary embodiments, the composite laminate comprises six layers and has an impact strength of about 3,278 N.

In some exemplary embodiments, the composite laminate has a fastener pull through strength of at least 260 lbf. In some exemplary embodiments, the composite laminate has a fastener pull through strength of at least 270 lbf.

In some exemplary embodiments, the composite laminate comprises six layers and has a fastener pull through strength of about 274 lbf.

In some exemplary embodiments, the composite laminate is stored as a roll. In some exemplary embodiments, the roll includes a core.

In one exemplary embodiment, a roof covering assembly comprises a weather resistant membrane, at least one insulation layer, and a composite laminate according to any of the embodiments disclosed or suggested herein, wherein the roof covering assembly is affixed to the roof deck.

In one exemplary embodiment, a rollable facing material comprises a composite laminate according to any of the embodiments disclosed or suggested herein, wherein the rollable facing material can be applied to a substrate.

In some exemplary embodiments, the substrate is a polyiso board or a gypsum board.

In one exemplary embodiment, a building panel for forming a wall or a ceiling of a structure is provided. The building panel comprises a plurality of polymeric sheets, each polymeric sheet defining a layer of the composite laminate and comprising a plurality of reinforcing fibers; wherein the polymeric sheets include a first polymeric sheet positioned so that the reinforcing fibers of the first polymeric sheet are oriented in a first direction; wherein the polymeric sheets include a second polymeric sheet positioned so that the reinforcing fibers of the second polymeric sheet are oriented in a second direction; wherein the layer defined by the first polymeric sheet is adjacent to the layer defined by the second polymeric sheet; and wherein the composite laminate comprises at least nine layers.

In some exemplary embodiments, the first direction differs from the second direction by 85° to 95°.

In some exemplary embodiments, the first direction is the same as the second direction.

In some exemplary embodiments, the first direction is orthogonal to the second direction.

In some exemplary embodiments, the first direction corresponds to the machine direction of the first polymeric sheet. In some exemplary embodiments, the second direction corresponds to the cross direction of the first polymeric sheet.

In some exemplary embodiments, at least one of the first polymeric sheet and the second polymeric sheet comprises about 10% to about 90% of a polymeric material and about 90% to about 10% of the reinforcing fibers. In some exemplary embodiments, at least one of the first polymeric sheet and the second polymeric sheet comprises about 20% to about 80% of a polymeric material and about 80% to about 20% of the reinforcing fibers. In some exemplary embodiments, at least one of the first polymeric sheet and the second polymeric sheet comprises about 40% to about 60% of a polymeric material and about 60% to about 40% of the reinforcing fibers.

In some exemplary embodiments, the composite laminate comprises at least 2 layers. In some exemplary embodiments, the composite laminate comprises at least 4 layers. In some exemplary embodiments, the composite laminate comprises at least 6 layers. In some exemplary embodiments, the composite laminate comprises at least 8 layers. In some exemplary embodiments, the composite laminate comprises from 2 to 12 layers. In some exemplary embodiments, the composite laminate includes 15-18 layers. In some exemplary embodiments, the composite laminate comprises up to about 40 layers.

In some exemplary embodiments, a facing material is affixed to at least one face of the composite laminate.

In some exemplary embodiments, the reinforcing fibers are glass fibers. In some exemplary embodiments, the glass fibers are made of E-CR glass.

In some exemplary embodiments, the building panel has a width of about 4 feet. In some exemplary embodiments, the building panel has a width greater than 4 feet. In some exemplary embodiments, the building panel has a width of at least 8 feet. In some exemplary embodiments, the building panel has a width of about 8 feet.

In some exemplary embodiments, the building panel has a length of about 8 feet. In some exemplary embodiments, the building panel has a length greater than 8 feet. In some exemplary embodiments, the building panel has a length of at least 10 feet. In some exemplary embodiments, the building panel has a length of at least 12 feet. In some exemplary embodiments, the building panel has a length of at least 14 feet. In some exemplary embodiments, the building panel has a length of at least 16 feet. In some exemplary embodiments, the building panel has a length of at least 18 feet. In some exemplary embodiments, the building panel has a length in the range of about 8 feet to about 20 feet.

In some exemplary embodiments, the building panel has a thickness less than 2 inches. In some exemplary embodiments, the building panel has a thickness less than 1 inch. In some exemplary embodiments, the building panel has a thickness equal to or less than ½ inch. In some exemplary embodiments, the building panel has a thickness of about ⅝ inch. In some exemplary embodiments, the building panel has a thickness of about ½ inch. In some exemplary embodiments, the building panel has a thickness of about ⅜ inch. In some exemplary embodiments, the building panel has a thickness of about ¼ inch.

In some exemplary embodiments, the building panel has a weight less than 2.31 lb/ft². In some exemplary embodiments, the building panel has a weight of about 2.31 lb/ft². In some exemplary embodiments, the building panel has a weight less than 1.6 lb/ft². In some exemplary embodiments, the building panel has a weight of about 1.6 lb/ft². In some exemplary embodiments, the building panel has a weight less than 1 lb/ft². In some exemplary embodiments, the building panel has a weight less than 0.5 lb/ft².

In some exemplary embodiments, the building panel has a shear strength in the range of about 0.19 ksi to about 1.84 ksi. In some exemplary embodiments, the building panel has a shear strength of at least about 0.30 ksi. In some exemplary embodiments, the building panel has a shear strength of at least about 0.40 ksi. In some exemplary embodiments, the building panel has a shear strength of at least about 0.50 ksi. In some exemplary embodiments, the building panel has a shear strength of at least about 0.60 ksi. In some exemplary embodiments, the building panel has a shear strength of at least about 0.70 ksi. In some exemplary embodiments, the building panel has a shear strength of at least about 0.80 ksi. In some exemplary embodiments, the building panel has a shear strength of at least about 0.90 ksi. In some exemplary embodiments, the building panel has a shear strength greater than about 1.0 ksi. In some exemplary embodiments, the building panel has a shear strength greater than about 1.25 ksi. In some exemplary embodiments, the building panel has a shear strength greater than about 1.5 ksi. In some exemplary embodiments, the building panel has a shear strength greater than about 1.75 ksi.

In some exemplary embodiments, the building panel has a water absorption of less than 50%. In some exemplary embodiments, the building panel has a water absorption of less than 40%. In some exemplary embodiments, the building panel has a water absorption of less than 30%. In some exemplary embodiments, the building panel has a water absorption of less than 20%. In some exemplary embodiments, the building panel has a water absorption of less than 15%. In some exemplary embodiments, the building panel has a water absorption of less than 10%. In some exemplary embodiments, the building panel has a water absorption of less than 5%.

Other aspects and features of the general inventive concepts will become more readily apparent to those of ordinary skill in the art upon review of the following description of various exemplary embodiments in conjunction with the accompanying figures.

### BRIEF DESCRIPTION OF THE DRAWINGS

The general inventive concepts, as well as embodiments and advantages thereof, are described below in greater detail, by way of example, with reference to the drawings in which:

FIG. 1A is a top perspective view of a conventional flat roof covering assembly. FIG. 1B is a diagram showing (a side view of) the various layers of the flat roof covering assembly of FIG. 1A. FIGS. 1C-1D are diagrams of various conventional installation approaches to affixing the roof covering assembly of FIGS. 1A-1B to a low-slope roof deck.

FIG. 2A is a diagram of a polymeric sheet, according to one exemplary embodiment. FIG. 2B is a diagram of the polymeric sheet of FIG. 2A rotated 90 degrees.

FIG. 3 is a diagram illustrating the stacking of the polymeric sheets of FIGS. 2A-2B to form a stack of the polymeric sheets, according to one exemplary embodiment.

FIG. 4 is a diagram illustrating a perspective view of the composite laminate coverboard material in the form of a roll, according to one exemplary embodiment.

FIG. 5 is a diagram illustrating a cross-sectional view of a 3-ply composite laminate coverboard material, according to one exemplary embodiment.

FIG. 6 is a diagram illustrating a cross-sectional view of a roof covering assembly, according to one exemplary embodiment.

FIG. 7 is a diagram illustrating a cross-sectional view of the 3-ply composite laminate coverboard material of FIG. 5 having a fibrous glass facer material applied to both an upper surface/face and lower surface/face thereof.

FIG. 8 is a diagram illustrating a building panel (e.g., wall or ceiling board) having a composite laminate core or body formed alternating (0° and 90°) layers of a fiber-reinforced polymeric sheet.

FIG. 9 is a diagram illustrating a cross-sectional view of the building panel of FIG. 8 having a fibrous glass facer material applied to both an upper surface/face and lower surface/face thereof.

FIG. 10 presents images showing the results of Class 4 impact testing carried out according to the UL 2218 test on three samples.

FIG. 11A is a graph illustrating the results of Class 4 impact testing carried out according to the UL 2218 test on various samples.

FIG. 11B is a graph illustrating the results of impact testing carried out according to the ASTM D3763 test on multiple samples.

FIG. 12 is a graph illustrating the results of a fastener pull through resistance test carried out according to a modified version of the ASTM D1761 standard on various samples.

FIG. 13 is a graph illustrating the results of a fastener withdrawal test carried out according to the ASTM C473 standard on multiple samples.

FIG. 14 is a graph illustrating the results of fire performance testing carried out in accordance with the ASTM E84 standard on various samples.

FIG. 15 is a graph illustrating the results of an adhesion test carried out according to the FM 4470 standard on several samples.

FIG. 16 is a graph illustrating the results of a flex test according to the ASTM C743 standard on various samples.

FIG. 17 is a graph illustrating the results of a shear strength test, according to a modified version of the ASTM D2344 standard (short-beam strength test) on multiple samples.

FIG. 18 is a graph illustrating the results of a water absorption test according to the ASTM D570 standard (water absorption at 24 hour test) on multiple samples.

FIG. 19 is a graph illustrating the improved impact resistance resulting from using the composite laminate material as a facer for a polyiso insulation board, according to the ASTM D3763 standard.

FIG. 20 is a graph illustrating the improved nail pull through resistance resulting from using the composite laminate material as a facer for a polyiso insulation board, according to a modified version of the ASTM D1761 standard.

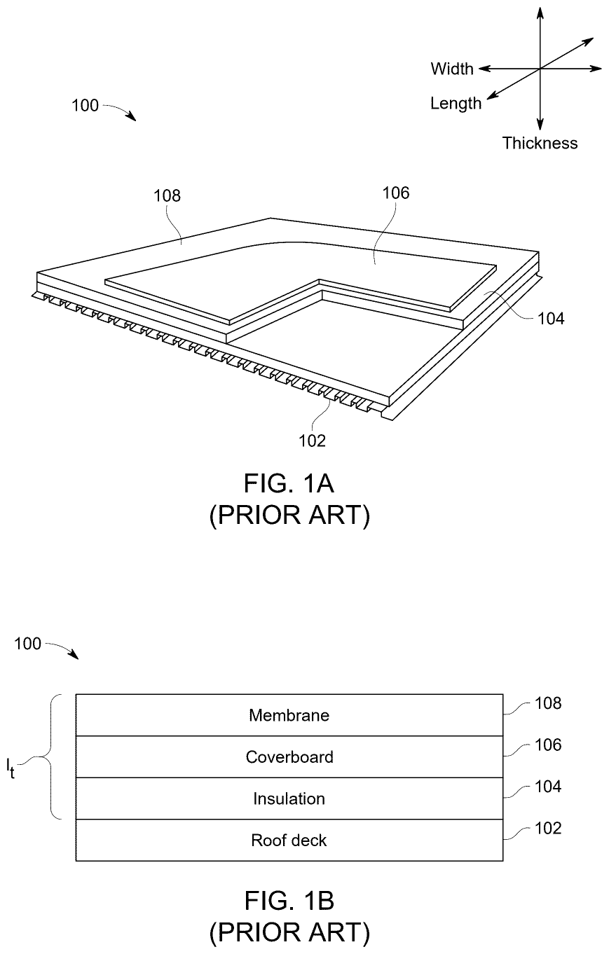

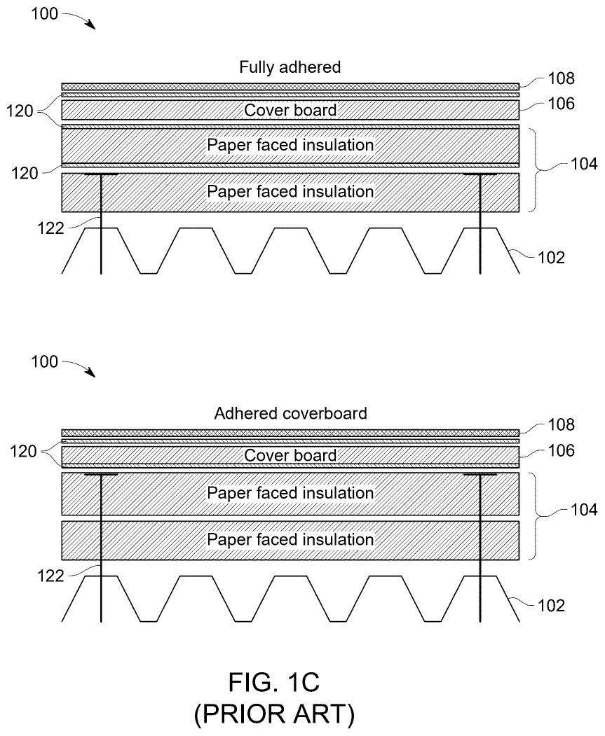

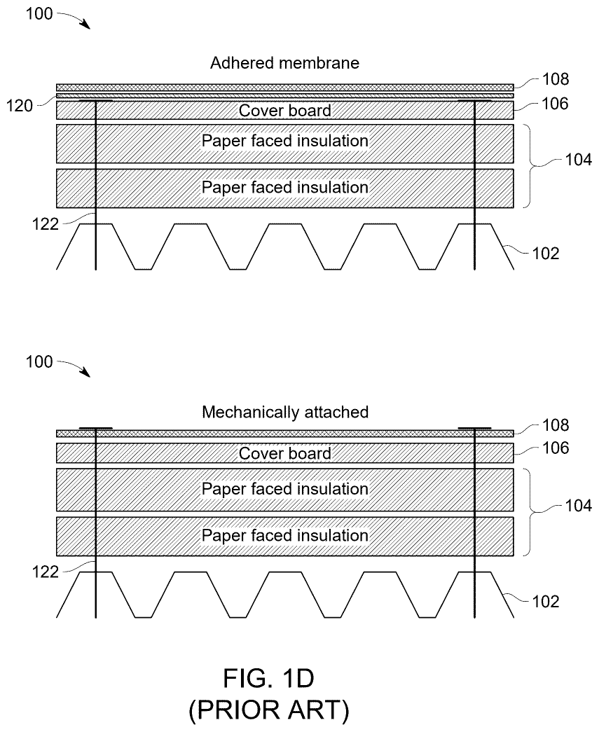

### DETAILED DESCRIPTION

Several illustrative embodiments will be described in detail with the understanding that the present disclosure merely exemplifies the general inventive concepts. Embodiments encompassing the general inventive concepts may take various forms and the general inventive concepts are not intended to be limited to the specific embodiments described herein.

The general inventive concepts relate to a composite laminate material that is suitable for use in forming a coverboard, a building panel, and/or a facing material.

### Coverboard

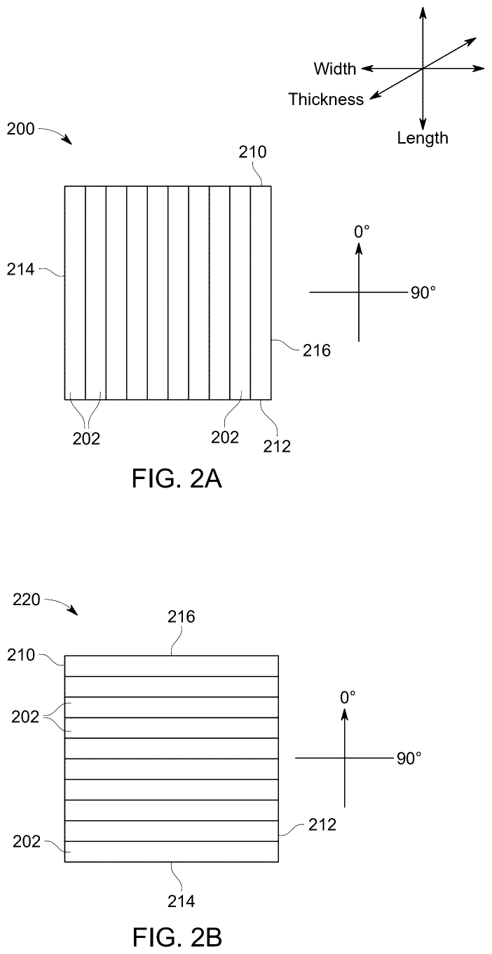

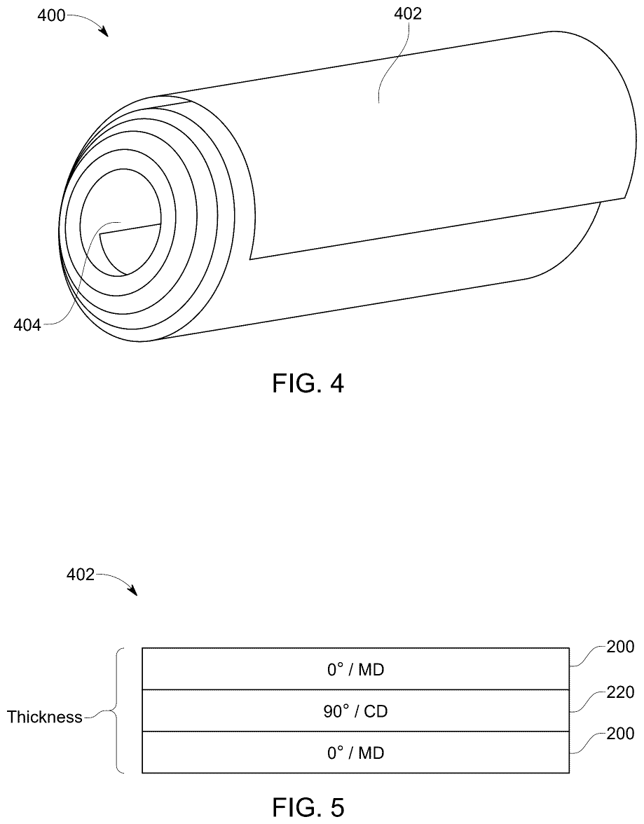

In one exemplary embodiment, a new and improved coverboard material is formed from a composite laminate (see FIG. 4). The composite laminate is comprised of a fiber-reinforced (e.g., with fiberglass) polymeric material, such as polypropylene (PP) tapes. It is contemplated that any suitable thermoplastic material or thermoplastic material containing blend could be used, as well as optional fillers and additives. It is further contemplated that any suitable reinforcement material (carbon, nylon, etc.) could be used. The polymeric material is formed into a first sheet 200, wherein many polymeric tapes 202 are oriented in a machine-direction (MD—0 degrees), as shown in FIG. 2A. The fibers reinforcing the polymeric tapes 202 are also substantially oriented in the machine—direction (MD-0 degrees). The sheet 200 has a length extending between a top edge 210 and a bottom edge 212 of the sheet 200. The sheet 200 has a width extending between opposite sides 214, 216 of the sheet 200. A second sheet 220 is formed by rotating an instance of the first sheet 200 by 90 degrees, such that the polymeric tapes 202 (as well as the reinforcing fibers therein) are substantially oriented in the cross-direction (CD—90 degrees), as shown in FIG. 2B. Other than their orientation, the sheets 200 and 220 are identical in construction.

In some exemplary embodiments, the sheets 200, 220 may be oriented in the same direction to simplify construction of the composite laminate.

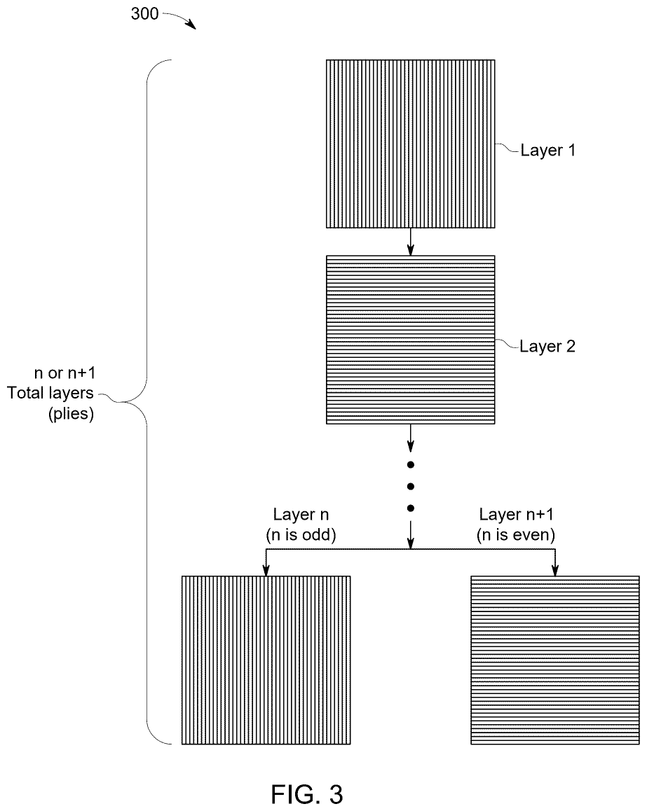

Alternating layers of the polymeric material are stacked such that every first sheet 200 is adjacent only to one or more second sheets 220 and vice versa. In this manner, a stack 300 of n sheets 200, 220 is formed, with n≥2, as generally illustrated in FIG. 3. Of course, the order of the n sheets 200, 220 could also be reversed, such that a second sheet 220 forms the first layer (i.e., layer 1) and a first sheet 200 forms the second layer (i.e., layer 2), with the sequence repeated for the remaining n sheets.

In some exemplary embodiments, one or more the sheets 200 may have different properties (e.g., reinforcement type or amount) than other sheets 200 in the composite laminate. Likewise, in some exemplary embodiments, one or more of the sheets 220 may have different properties (e.g., reinforcement type or amount) than other sheets 200 in the composite laminate.

During and/or after formation of the stack 300, the alternating MD and CD layers of the polymeric sheets 200, 220 are laminated together to form a pliable multi-ply coverboard material 402, as shown in FIG. 4. Any suitable lamination technique (e.g., using heat, pressure, welding, and/or adhesives) can be used to join the layers together. For example, in one embodiment, heating the layers in the stack softens the polypropylene enough so that the plies fuse together.

In general, the pliable multi-ply coverboard 402 can be made from 2 to 40 layers (plies) of the polymeric material, with 2 to 10 plies of the polymeric sheets likely sufficient for many coverboard applications. Given its construction, the coverboard material 402 can readily be stored in the form of a roll 400, as shown in FIG. 4, to facilitate storage and transport thereof. Other advantages of the rollable nature of the coverboard material 402 are described herein. In some exemplary embodiments, the roll 400 includes a core 404 (e.g., a paperboard core) around which the coverboard material 402 is wound. Of course, the coverboard material 402 could be cut into pliable sheets/panels for shipping, storage, and installation as well. Likewise, the coverboard material 402 could be formed into more rigid or semi-rigid panels, such as by increasing the number of plies used to form the laminate and/or by application of certain facing materials.

In one exemplary embodiment the coverboard 402 includes three layers of the polymeric sheets 200, 220, as shown in FIG. 5. The thickness of the coverboard 402 is generally tied to the number of layers of the polymeric sheets therein. In this manner, a thickness of the coverboard 402 is readily adjustable during the aforementioned stacking process. Furthermore, control of the thickness may be more precise and/or flexible than with conventional coverboards formed of gypsum or polyiso cores.

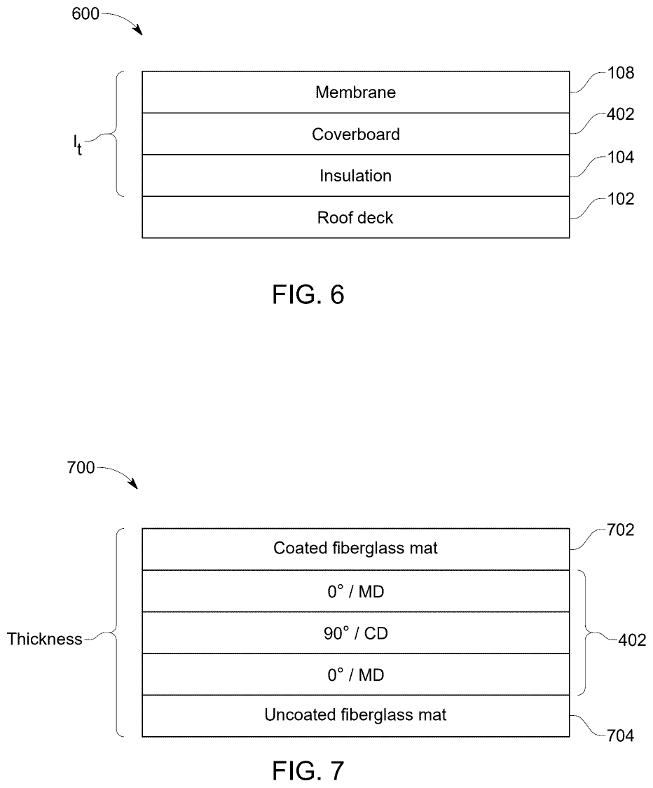

The coverboard 402 will typically be used with a weather resistant membrane and one or more layers of insulation, as known in the art, as part of a roof covering assembly. Accordingly, an improved roof covering assembly/installation 600 for a low-slope roof deck is provided, as shown in FIG. 6. The coverboard 402 can be joined directly to the roof deck 102 (e.g., using fasteners passing therethrough) or can be joined indirectly to the roof deck 102 (e.g., by being glued to the insulation layer 104, which is itself fastened or adhered to the roof deck 102). As known in the art, any means of joining the membrane 108, the pliable multi-ply coverboard material 402, and the insulation 104 to the roof deck 102 is contemplated.

In some exemplary embodiments, a facing material (e.g., woven scrim, non-woven mat, coated glass facer, polymeric film) can be applied to either or both major sides (faces) of the coverboard 402. For example, application of an uncoated, non-woven fiberglass veil to one face of the coverboard material 402 can significantly increase the compatibility of the coverboard with an adhesive system and/or insulation layer. As another example, application of a coated, non-woven fiberglass mat (i.e., a coated glass facer (CGF)) on one face of the coverboard material 402 can contribute to an improved impact resistance, structural strength, and/or fire performance of the coverboard.

An exemplary embodiment of a faced coverboard 700 is shown in FIG. 7, wherein the coverboard material 402 includes a coated fiberglass non-woven mat 702 on an upper face thereof and an uncoated fiberglass non-woven mat 704 on a lower face thereof. Properties of these facing materials can be adjusted, for example, based on the filler material, binder, and additives used in the coated facing material and/or the pore size (porosity), air permeability, basis weight, LOI, fiber type, fiber size, and binder chemistry of the uncoated facing material.

The relatively thin nature of the coverboard material 402 contributes to its pliability and rollability. In general, the coverboard material 402 will have a thickness of less than ½ inch.

Additionally, the coverboard material 402 can be significantly lighter than conventional coverboards. By way of example, a conventional 4 foot by 8 foot gypsum coverboard can weigh between 48-112 lbs (i.e., 1.5-3.5 lbs/ft²). Conversely, a 3-ply embodiment of the coverboard material 402 can have a weight of about 0.23 lbs/ft².

Furthermore, because the coverboard material 402 can be made with larger width and length dimensions and stored on a roll, a more efficient installation is expected. In particular, it is contemplated that fewer pieces of the pliable multi-ply coverboard will be needed than with conventional coverboards. Consider that for a 100,000 ft² roof deck, approximately 3,125 conventional gypsum coverboards (each being 4 feet wide by 8 feet long) would need to be positioned on and secured to the roof deck. Conversely, with a roll of the coverboard 402 produced to have a width of 8 feet and a length of 50 feet, about 250 rolls of the coverboard material 402 would suffice to cover the same roof deck. In this example, as many as 2,875 fewer discrete pieces would need to be installed to cover the roof deck. Consequently, because the coverboard material 402 can be unrolled to cover the insulation on the roof deck, installation should be quicker than that requiring manual placement of many individual coverboards.

Furthermore, fewer fasteners will need to be installed to secure the coverboard material 402 as compared to conventional coverboard panels. In the aforementioned example for a 100,000 ft² roof deck, each of the conventional 4 foot by 8 foot gypsum coverboards might require 16 fasteners to secure the coverboard to the roof deck. Consequently, approximately 50,000 fasteners (3,125 boards×16 fasteners each) would be needed to fasten the coverboards to the roof deck, requiring a considerable amount of installer time and energy. Conversely, the rollable coverboard material 402 would require an order of magnitude smaller number of fasteners for installation to the roof deck. Furthermore, in a case where the rollable coverboard material 402 includes a peel-and-stick adhesive on its lower surface, elimination of most, if not all, of the 50,000 fasteners could be achieved, resulting in a substantial reduction in the installation time/effort. Furthermore, fewer seams (i.e., potential thermal breaks; moisture paths) will result with the pliable multi-ply coverboard 402.

Similarly, because the coverboard material 402 can be made to any practical length, less time and effort needs to be spent on packaging and unpacking many individual coverboard sections. Additionally, the rolled nature of the coverboard material 402 may allow for a larger volume of the material to be transported than with conventional coverboard panels, for a given transport container size. Stated another way, a single roll of the coverboard material 402 may provide more roofing coverage given the volume the roll occupies, as compared to the number of packaged conventional 4 foot by 8 foot gypsum coverboards that could occupy the same volume.

During installation, the coverboard material 402 can be cut to size (i.e., making width and/or length adjustments) as necessary.

As noted above, since the coverboard material 402 can be made by a continuous (laminating) process, it can be made to any practical length. Similarly, because the coverboard material 402 is made by laminating plies of the fiber-reinforced polymeric sheets 200, 220, it can be made to any practical width, which is typically only limited by the manufacturing process. Additionally, as also noted above, the thickness of the coverboard material 402 can be readily adjusted during the manufacturing process by varying the number of plies of the fiber-reinforced polymeric sheets 200, 220 laminated together.

In some exemplary embodiments, the coverboard material 402 has a width greater than 4 feet. In some exemplary embodiments, the coverboard material 402 has a width of about 4 feet. In some exemplary embodiments, the coverboard material 402 has a width greater than 8 feet. In some exemplary embodiments, the coverboard material 402 has a width of about 8 feet. In some exemplary embodiments, the coverboard material 402 has a width in the range of about 7 feet to about 10 feet. In some exemplary embodiments, the coverboard material 402 has a width of about 9 feet. In some exemplary embodiments, the coverboard material 402 has a width of at least 10 feet.

In some exemplary embodiments, the coverboard material 402 has a length of at least 20 feet. In some exemplary embodiments, the coverboard material 402 has a length of at least 40 feet. In some exemplary embodiments, the coverboard material 402 has a length greater than 60 feet. In some exemplary embodiments, the coverboard material 402 has a length greater than 80 feet. In some exemplary embodiments, the coverboard material 402 has a length greater than 100 feet. In some exemplary embodiments, the coverboard material 402 has a length greater than 500 feet. In some exemplary embodiments, the coverboard material 402 has a length of at least 1,000 feet.

In some exemplary embodiments, the coverboard material 402 has a thickness of less than ½ inch. In some exemplary embodiments, the coverboard material 402 has a thickness equal to or less than ⅛ inch. In some exemplary embodiments, the coverboard material 402 has a thickness of about ⅛ inch.

In some exemplary embodiments, the coverboard material 402 comprises from 3 to 15 total plies of the alternating fiber-reinforced polymeric sheets 200, 220. In some exemplary embodiments, the coverboard material 402 comprises from 3 to 12 total plies of the alternating fiber-reinforced polymeric sheets 200, 220. In some exemplary embodiments, the coverboard material 402 comprises from 3 to 9 total plies of the alternating fiber-reinforced polymeric sheets 200, 220. In some exemplary embodiments, the coverboard material 402 comprises from 3 to 6 total plies of the alternating fiber-reinforced polymeric sheets 200, 220. In some exemplary embodiments, the coverboard material 402 comprises from 4 to 8 total plies of the alternating fiber-reinforced polymeric sheets 200, 220.

In some exemplary embodiments, the coverboard material 402 has a width greater than 8 feet, a length greater than 50 feet, and a thickness of less than ½ inch.

In some exemplary embodiments, the coverboard material 402 has a width of about 9 feet, a length of at least 80 feet, and a thickness of about ⅛ inch.

Although the pliable multi-ply coverboard material 402 is capable of being stored and transported on a roll, as described herein, it could also be provided in cut sheets having desired dimensions. A thickness of the pliable multi-ply coverboard 402 (e.g., <½″) is generally less than the thickness of a conventional coverboard panel (e.g., ≥½″).

Coverboards serve to extend the lifespan of a roof system by enhancing the overall performance of the roof system. Coverboards enhance hail resistance, walkability, and even puncture resistance. Additionally, coverboards protect the roof system from abuse from tool drops during after installation. In order to meet these demands, the impact strength of a coverboard is a critical property. The coverboard material 402 has been shown to be capable of providing impact strength (N) superior to that of conventional coverboard panels, in accordance with ASTM D3763. For example, a 6-ply sample of the coverboard material 402 exhibited an impact strength of about 3,278 N, while a conventional HD polyiso coverboard panel exhibited an impact strength of about 411 N and a conventional gypsum-based coverboard panel (with fiberglass facings applied thereto) exhibited an impact strength of about 1,402 N. The impact strength of the coverboard material 402 makes it suitable for very severe hail (VSH) applications.

Coverboards can increase the wind uplift rating of a roof assembly by providing a strong, high-performing layer of protection. During severe weather events, high winds exert significant pressure on a roof system. Roofing coverboards help reinforce the roof assembly, enhancing the resistance to this wind induce pressure and reducing the likelihood of damage or failure of the roof system during storms. The resistance to wind uplift forces can be correlated to fastener pull through strength of the coverboard. The coverboard material 402 has been shown to be capable of providing fastener pull through strength (lbf), representing fastener retention strength, superior to that of conventional coverboard panels, in accordance with ASTM D1761 (as modified to use a 3 inch ribbed galvalume plate and a 4 inch fastener). For example, a 6-ply sample of the coverboard material 402 exhibited a fastener pull through strength of about 274 lbf, while a conventional HD polyiso coverboard panel exhibited a fastener pull through strength of about 120 lbf and a conventional gypsum-based coverboard panel (with fiberglass facings applied thereto) exhibited a fastener pull through strength of about 253 lbf. The fastener pull through strength of the coverboard material 402 makes it suitable for high-wind exposure applications.

Fire safety is a key consideration in building design. A roof system must be engineered to offer the necessary fire resistance required by region and/or application/occupant. Coverboards are often designed to improve the fire resistance of the roof system, thus increasing the protection of the occupants, structure, and property. For fire performance (e.g., measured by E84 fire testing), the coverboard material 402 can use a relatively high fiber (e.g., glass) content, the aforementioned facer(s), fire-resistant coatings/fillers for the facer(s), and additives (e.g., fire retardants) to the polymeric material.

### Building Panel

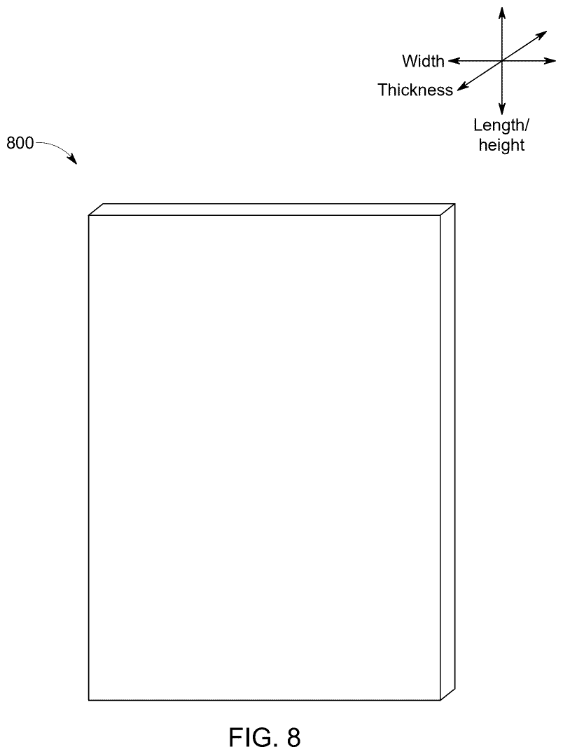

Similar to the coverboard material 402 described herein, the stack 300 of alternating MD and CD layers of the fiber-reinforced polymeric sheets 200, 220 could also be used to form a relatively rigid board-like member or panel 800, as shown in FIG. 8. In this manner, the composite laminate (i.e., the fiber-reinforced polymeric) panel 800 could be used as a building (e.g., wall, ceiling) panel, functioning as a suitable replacement for conventional building (e.g., drywall, sheetrock) panels formed from a gypsum, cement, or similar core material that has to dry and set/harden.

Typically, the rigidity and performance properties of the panel 800 are achieved by using a higher number of the plies of the sheets 200, 220 to form the panel 800. In some exemplary embodiments, at least 2 plies are used to form the building panel 800. In some exemplary embodiments, at least 4 plies are used to form the building panel 800. In some exemplary embodiments, at least 6 plies are used to form the building panel 800. In some exemplary embodiments, at least 8 plies are used to form the building panel 800. In some exemplary embodiments, at least 10 plies are used to form the building panel 800. In some exemplary embodiments, at least 12 plies are used to form the building panel 800. In some exemplary embodiments, 2 to 6 plies are used to form the panel 800. The number of plies of the fiber-reinforced polymeric sheets 200, 220 that form the panel 800 will essentially define core thickness of the panel 800.

The number of plies will often impact the ability of the material (i.e., the panel 800) to be rolled. In some exemplary embodiments, 6 or fewer plies may be used when a rollable material is desired.

In some exemplary embodiments, a facing material (e.g., woven scrim, non-woven mat, coated glass facer, polymeric film, metal foil) can be applied to either or both major sides (faces) of the building panel 800. For example, application of an uncoated, non-woven fiberglass veil to one face of the panel 800 (i.e., an outer facing side of the panel 800) can increase the strength and stability of the panel 800. As another example, application of a coated, non-woven fiberglass mat (i.e., a coated glass facer (CGF)) on one face of the panel 800 (i.e., an inner facing side of the panel 800) can provide surface characteristics (e.g., smoothness) more suitable for finishing (e.g., painting) the surface. Other conventional facing materials (e.g., paper) could also be used on one or both faces of the panel 800. Thus, the facing material can be the same or different on opposite faces of the building panel 800.

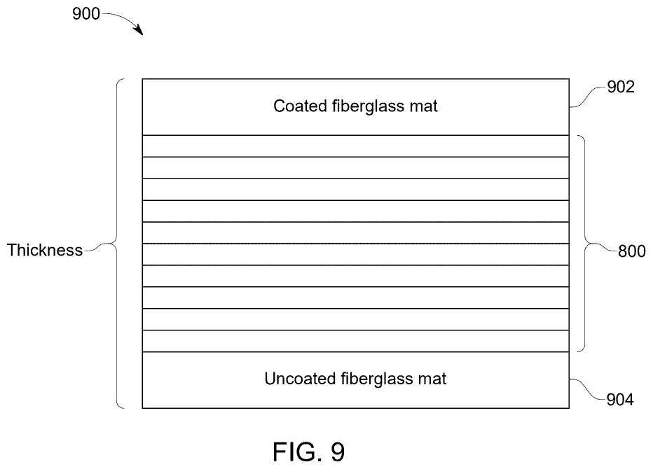

An exemplary embodiment of a faced building panel 900 is shown in FIG. 9, wherein the panel 800 includes a coated fiberglass non-woven mat 902 on an upper/inner face thereof and an uncoated fiberglass non-woven mat 904 on a lower/outer face thereof. Properties of these facing materials can be adjusted, for example, based on the filler material or additives used in the coated facing material and/or the pore size (porosity) of the uncoated facing material.

Additionally, since the building panel 800 is formed from multiple plies of the fiber-reinforced polymeric sheets 200, 220, as opposed to a material such as gypsum that has to set over time, problems such as the gypsum flowing through the facing material and producing undesirable visible irregularities in the outer appearance of the panel (generally referred to as “bleed through”) are avoided. Furthermore, its material composition makes it less susceptible to water/moisture absorption than conventional gypsum board. Water absorption can be evaluated in accordance with the 24 hour submersion procedure specified in ASTM D570.

Further still, because the production of the panels 800 does not require a significant amount of time or energy to set the core/body material, the panels 800 can be produced more efficiently (e.g., quicker, lower energy costs) than with conventional gypsum boards.

When using the building panel 800/900 in a wall or ceiling application, it can be connected to the framing members (e.g., wood or metal studs) in any conventional manner, such as using screws. The material composition of the panel 800/900 allows it to be thinner and/or lighter than an otherwise identical building panel that uses a gypsum or similar core instead of the core formed from the fiber-reinforced polymeric sheets 200, 220. For example, conventional gypsum boards are typically ½ inch or ⅝ inch thick and weigh 1.6 lbs/ft² and 2.2 lbs/ft², respectively. Conversely, exemplary embodiments of the panel 800/900 can be less than 0.2 inch thick and weight less than 1.0 lbs/ft².

In one exemplary embodiment, the building panel 800/900 can be used as a tile backer. Conventional tile backers are often cement boards or gypsum boards with modified cores. These conventional products are relatively heavy (about 2.35 lbs/ft²), but are desirable due to their fire resistance, moisture resistance, mold resistance, and sag resistance. The reinforced polymeric tapes used to form the composite laminates that make up the building panel 800/900 are able to provide the required fire resistance, moisture resistance, mold resistance, and sag resistance. Thus, the building panel 800/900 can be engineered to offer the same or better fire, moisture, mold, and/or sag performance as conventional boards but with a substantial reduction in weight.

Because of its construction, the panel 800 can be made to have practically any suitable dimensions.

In some exemplary embodiments, the panel 800 has a width of about 4 feet. In some exemplary embodiments, the panel 800 has a width greater than 4 feet. In some exemplary embodiments, the panel 800 has a width of at least 8 feet. In some exemplary embodiments, the panel 800 has a width of about 8 feet.

In some exemplary embodiments, the panel 800 has a length of about 8 feet. In some exemplary embodiments, the panel 800 has a length greater than 8 feet. In some exemplary embodiments, the panel 800 has a length of at least 10 feet. In some exemplary embodiments, the panel 800 has a length of at least 12 feet. In some exemplary embodiments, the panel 800 has a length of at least 14 feet. In some exemplary embodiments, the panel 800 has a length of at least 16 feet. In some exemplary embodiments, the panel 800 has a length of at least 18 feet. In some exemplary embodiments, the panel 800 has a length in the range of about 8 feet to about 16 feet.

In some exemplary embodiments, the panel 800 has a thickness less than 2 inches. In some exemplary embodiments, the panel 800 has a thickness less than 1 inch. In some exemplary embodiments, the panel 800 has a thickness equal to or less than ½ inch. In some exemplary embodiments, the panel 800 has a thickness of about ⅝ inch. In some exemplary embodiments, the panel 800 has a thickness of about ½ inch. In some exemplary embodiments, the panel 800 has a thickness of about ⅜ inch. In some exemplary embodiments, the panel 800 has a thickness of about ¼ inch.

In some exemplary embodiments, the panel 800 has a weight less than 2.31 lb/ft². In some exemplary embodiments, the panel 800 has a weight of about 2.31 lb/ft². In some exemplary embodiments, the panel 800 has a weight less than 1.6 lb/ft². In some exemplary embodiments, the panel 800 has a weight of about 1.6 lb/ft². In some exemplary embodiments, the panel 800 has a weight less than 1 lb/ft². In some exemplary embodiments, the panel 800 has a weight less than 0.5 lb/ft².

### Rollable Facing Material

Similar to the coverboard material 402 described herein, the stack 300 of alternating MD and CD layers of the fiber-reinforced polymeric sheets 200, 220 could also be used to form a relatively pliable continuous sheet of facing material. The facing material could have the same construction as the coverboard material 402 (see FIG. 5) and could be stored on a roll (e.g., the roll 400). In this manner, the facing material is a composite laminate that can be rolled out, cut to size, and adhered or otherwise interfaced with a face/side of a substrate (e.g., an HD polyiso board).

Given its construction (of multiple plies of the sheets 200, 220), a thickness of the facing material is more readily adjustable than some conventional facing materials (e.g., paper).

In general, the facing material is intended to provide some performance benefit or improved property to the substrate on which it is applied. For example, the facing material has been shown to be capable of improving the impact strength (N) of a substrate to which the facing material is attached, in accordance with ASTM D3763. For example, a HD polyiso foam board without any facing material has an impact strength of about 411 N. Conversely, a 3-ply sample of the facing material attached to a bottom face (further from the likely impact source) of the HD polyiso board exhibited an impact strength of about 1,996 N, while the same 3-ply sample of the facing material attached to a top face (closer to the likely impact source) of the HD polyiso board exhibited an impact strength of about 2,488 N.

Additionally, the facing material has been shown to be capable of improving the fastener pull through strength (i.e., fastener retention) of a substrate to which the facing material is attached, in accordance with ASTM D1761 (as modified to use a 3 inch ribbed galvalume plate and a 4 inch fastener). For example, a HD polyiso foam board without any facing material has a fastener pull through strength of about 120 lbf. Conversely, a 3-ply sample of the facing material attached to a bottom face (further from the head of the fastener) of the HD polyiso board exhibited a fastener pull through strength of about 499 lbf, while the same 3-ply sample of the facing material attached to a top face (closer to the head of the fastener) of the HD polyiso board exhibited a fastener pull through strength of about 300 lbf.

Other uses for the facing material might be to cover old wall and/or ceiling surfaces. For example, the facing material might be used to rehabilitate (i.e., improve the appearance of) these surfaces. The facing material (e.g., coated glass facer) is smoother than a conventional facer used for gypsum boards, which can provide improved aesthetics. A conventional gypsum board facer requires a Gurley air porosity of 20-80 seconds for moisture to escape (from the setting gypsum) during the manufacturing process. Conversely, the inventive facing material can be more closed off (e.g., having a Gurley air porosity of over 500 seconds), which provides a smoother surface that is easier to finish and paint. For similar reasons, the facing material might be used to improve the acoustic performance of a substrate.

### Material Properties

In assessing the performance of the inventive composite laminate material (e.g., the coverboard 402), twenty two sample constructions, as shown in Tables 1 and 2 below, were subjected to various tests. Table 1 shows the different layers forming the composite laminate of each sample.

TABLE 1

| | Top | Subsequent Layers (from top to bottom) | | | | | | | | |
|---|---|---|---|---|---|---|---|---|---|---|
| Sample | Layer | L-2 | L-3 | L-4 | L-5 | L-6 | L-7 | L-8 | L-9 | L-10 |
| A | 1 | 1 | | | | | | | | |
| B | 1 | 3 | | | | | | | | |
| C | 1 | 4 | 3 | | | | | | | |
| D | 1 | 4 | 1 | | | | | | | |
| E | 1 | 1 | 1 | | | | | | | |
| F | 1 | 3 | 1 | | | | | | | |
| G | 2 | 1 | 2 | | | | | | | |
| H | 2 | 1 | 1 | 2 | | | | | | |
| I | 2 | 1 | 3 | 2 | | | | | | |
| J | 2 | 1 | 4 | | | | | | | |
| K | 2 | 1 | 3 | 4 | | | | | | |
| L | 2 | 1 | 4 | 3 | 2 | | | | | |
| M | 2 | 1 | 4 | 1 | 2 | | | | | |
| N | 2 | 1 | 4 | 1 | 4 | | | | | |
| O | 2 | 1 | 1 | 1 | 4 | | | | | |
| P | 2 | 1 | 3 | 1 | 4 | | | | | |
| Q | 2 | 1 | 3 | 1 | 3 | 3 | 1 | 3 | 1 | 2 |
| R | 2 | 1 | 3 | 1 | 1 | 3 | 1 | 2 | | |
| S | 2 | 1 | 3 | 4 | 1 | 2 | | | | |
| T | 2 | 1 | 3 | 1 | 1 | 3 | 1 | 2 | | |
| U | 2 | 1 | 3 | 4 | 1 | 2 | | | | |
| V | 2 | 1 | 3 | 1 | 2 | | | | | |

where:
1 is a layer (ply) of fiberglass reinforced polypropylene tapes oriented in the machine direction;
2 is a coated glass facer as a facing material;
3 is a layer (ply) of fiberglass reinforced polypropylene tapes oriented in the cross direction; and
4 is a non-woven mat as a ply or facing material, the non-woven mat made up glass fibers having an average diameter or approximately 13 μm and an average length of approximately 19 mm, which are held together by a urea formaldehyde binder, wherein the binder content results in approximately 24% LOI.

Table 2 shows the ratio of fiberglass used to reinforce the polymeric material (i.e., polypropylene) in each sample.

TABLE 2

| | Core | Core |
|---|---|---|
| | Fiberglass | Polypropylene |
| Sample | % | % |
| A | 58% | 42% |
| B | 58% | 42% |
| C | 58% | 42% |
| D | 58% | 42% |
| E | 58% | 42% |
| F | 58% | 42% |
| G | 58% | 42% |
| H | 58% | 42% |
| I | 58% | 42% |
| J | 58% | 42% |
| K | 58% | 42% |
| L | 58% | 42% |
| M | 58% | 42% |
| N | 58% | 42% |
| O | 58% | 42% |
| P | 58% | 42% |
| Q | 49% | 51% |
| R | 51% | 49% |
| S | 42% | 58% |
| T | 58% | 42% |
| U | 58% | 42% |
| V | 58% | 42% |

In general, the ratio of the reinforcement material (e.g., fiberglass) to the polymeric material (e.g., polypropylene) making up each ply of the composite laminate can vary depending on the desired properties of the composite laminate. For example, one or more plies of the composite laminate has about 10% to about 90% of the polymeric material and about 90% to about 10% of the reinforcement material. In some exemplary embodiments, one or more plies of the composite laminate comprises about 20% to about 80% of the polymeric material and about 80% to about 20% of the reinforcement material. In some exemplary embodiments, one or more plies of the composite laminate comprises about 40% to about 60% of the polymeric material and about 60% to about 40% of the reinforcement material.

In some exemplary embodiments, all of the plies of the composite laminate have the same composition and only vary by their orientation (which may or may not be the same).

Impact testing was carried on a subset of the samples, according to the UL 2218 test. As shown in Table 3 below, there are four classes of impact testing under UL 2218, which differ by the diameter of the steel ball used, the distance the steel ball is dropped from the target, and the kinetic energy imparted to the steel ball.

TABLE 3

| | Steel Ball Diameter | | Distance | | Kinetic Energy | |
|---|---|---|---|---|---|---|
| Class | in | mm | ft | m | ft-lbf | J |
| 1 | 1.25 | 31.8 | 12.0 | 3.7 | 3.53 | 4.78 |
| 2 | 1.5 | 38.1 | 15.0 | 4.6 | 7.35 | 9.95 |
| 3 | 1.75 | 44.5 | 17.0 | 5.2 | 13.56 | 18.37 |
| 4 | 2 | 50.8 | 20.0 | 6.1 | 23.71 | 32.12 |

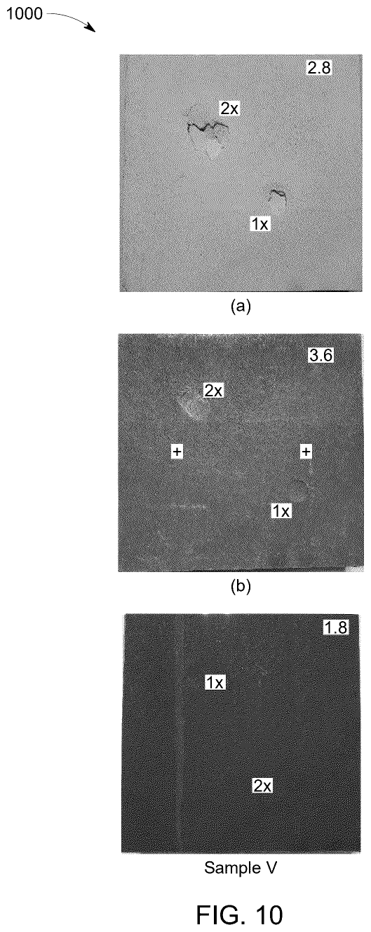

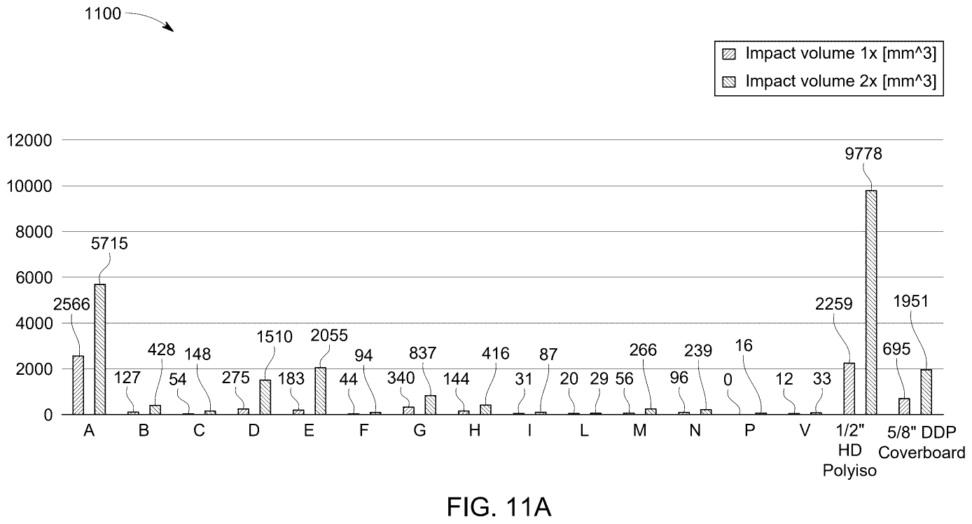

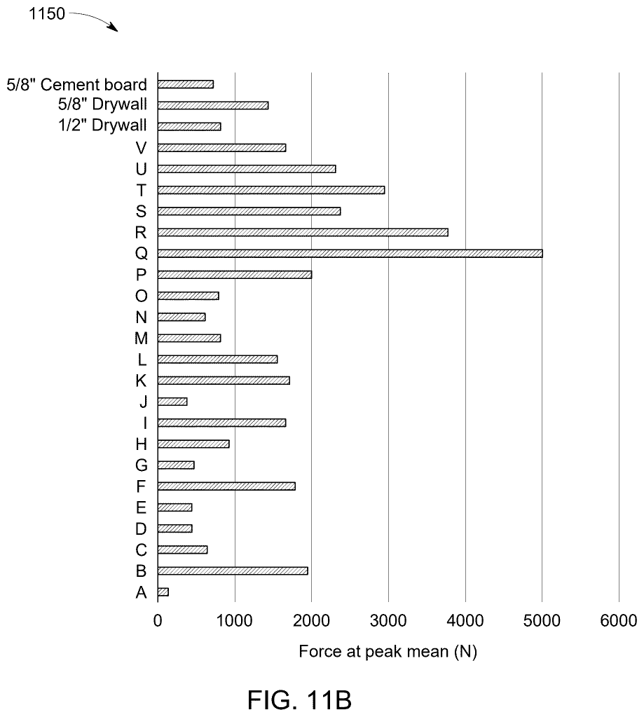

Multiple samples were evaluated. In each case, the sample substrate was adhered to a 2 inch thick, paper faced polyiso board using a commercially available solvent based roofing adhesive. The test was carried out according to Class 4. Thus, a 2 inch steel ball was dropped from 20 feet onto the samples (with an approximate kinetic energy of 23.71 ft-lbf or 32.12 J). Two impact conditions were measured for each sample: (i) a single impact; and (ii) two impacts in the same location. A volumetric size (mm³) of the impact created under both conditions was measured using a Keyence VR 6000 optical profilometer. In the images 1000 of FIG. 10, the two impact conditions are shown for a conventional ½ inch HD polyiso coverboard (a), a conventional ⅝ inch gypsum coverboard (b), and one embodiment of the inventive coverboard having 3 plies and a coated glass facer on each side thereof (i.e., Sample V). The Class 4 impact results (both conditions) for several of the samples (i.e., Samples A, B, C, D, E, F, G, H, I, L, M, N, P, and V) are shown in the graph 1100 of FIG. 11A, along with the results for a conventional ½ inch polyiso coverboard and a conventional ⅝ inch gypsum coverboard.

In the context of building panels, additional impact testing was carried out on samples of the composite laminate material (i.e., Samples A-V), as well as samples from three representative, commercially available panels (i.e., ½ inch drywall, ⅝ inch drywall, and ⅝ inch cement board tile backer). The testing was in accordance with the ASTM D3763 standard. The test results are shown in the graph 1150 of FIG. 11B.

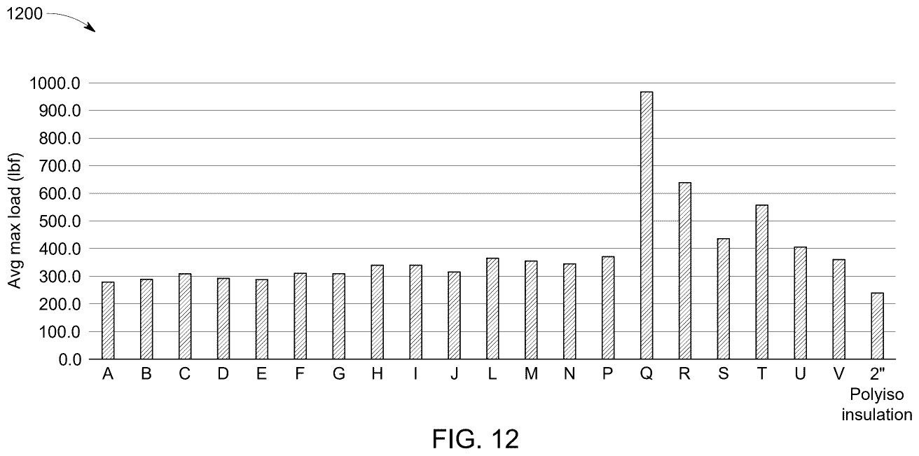

A fastener pull through resistance test was also conducted, according to a modified version of the ASTM D1761 standard, wherein a 3 inch ribbed galvalume plate and a 4 inch fastener resembling a screw were used. This test is commonly used to assess fastener performance of roof deck boards. The test was carried out on various samples of the composite laminate material (i.e., Samples A, B, C, D, E, F, G, H, I, J, K, L, M, N, P, Q, R, S, T, U, and V), along with a sample from a conventional 2 inch polyiso insulation board. The test results are shown in the graph 1200 of FIG. 12.

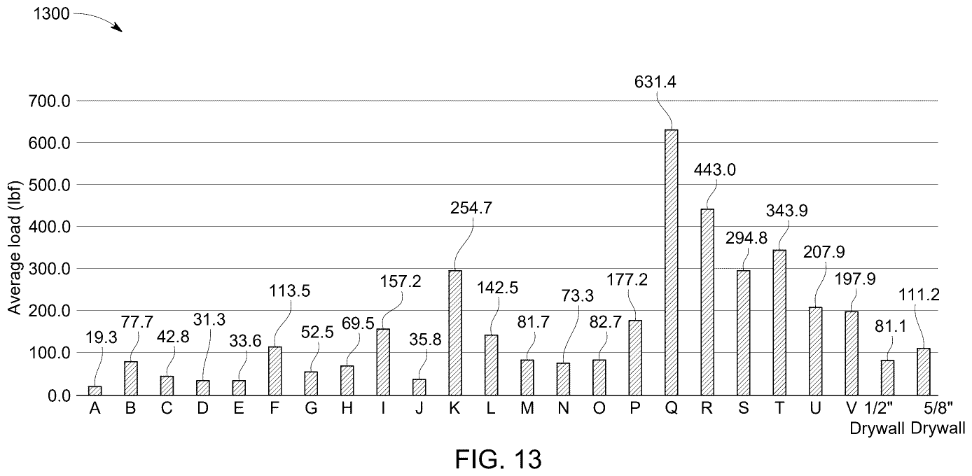

A fastener pull through resistance test was also conducted, according to the ASTM C473 standard. This test is commonly used to assess fastener performance of (gypsum) wall boards. Here, the fastener resembled a nail. The test was carried out on the samples of the composite laminate material (i.e., Samples A-V), along with samples from a conventional ½ inch gypsum board and a conventional ⅝ inch gypsum board. The test results are shown in the graph 1300 of FIG. 13.

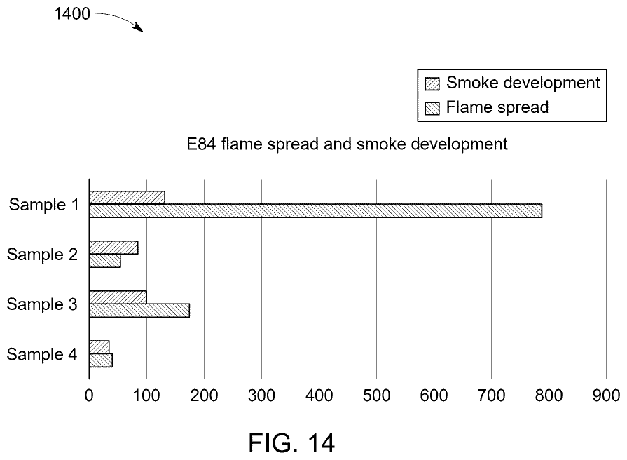

A fire performance (i.e., smoke development and flame spread) test was also conducted, according to the ASTM E84 standard. Here, a sample from a 2 inch thick, paper faced polyiso insulation board (Sample 1), a sample from a ½ inch thick, glass faced polysio coverboard (Sample 2), a 3-ply embodiment of the composite laminate without any coated glass facer (Sample 3), and a 3-ply embodiment of the composite laminate with a coated glass facer (Sample 4) were tested. The test results are shown in the graph 1400 of FIG. 14.

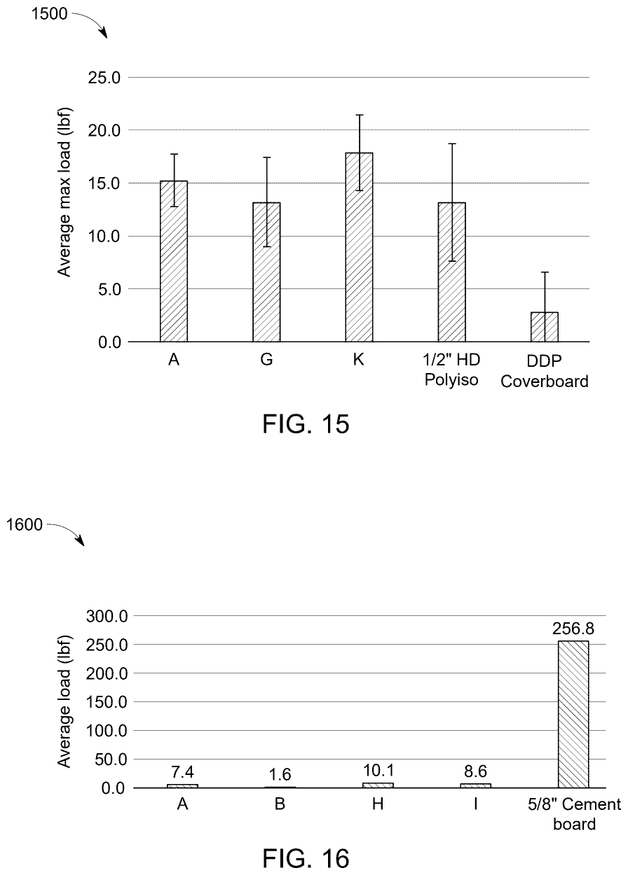

Additionally, an adhesion test was performed on several of the samples, according to the FM 4470 standard. This test is used to predict how well a membrane adheres to a substrate. If the adhesion is poor, the membrane will detach during high wind events. In particular, this test evaluated how much force (lbf) was required to separate the sample from a substrate intended to approximate an installation surface (i.e., membrane). Here, the same peel-and-stick membrane material (i.e., EverGuard SA TPO by GAF) was used for each of the samples. The test was carried out on several samples (i.e., Samples A, G, and K), along with samples from a conventional ½ inch polyiso coverboard and a conventional ⅝ inch gypsum coverboard. The test results are shown in the graph 1500 of FIG. 15. Here, the data shows comparable test results to conventional products, such that no decrease in performance is expected.

The flexural strength of building panels, including gypsum-based boards, is critical to ensuring that the material can withstand the forces imposed on the building panels during installation and from daily wear and tear. High flexural strength allows the material to avoid cracking and bending when exposed to such forces. Building panels that do not break or exhibit higher flexural strength than conventional commonly used building panels, as measured in accordance with the ASTM C473 standard, would be expected to have higher resistance to cracking when exposed to bending forces in the field. Accordingly, in a gypsum flex test, according to the ASTM C473 standard, several samples (i.e., Samples A, B, H, and I), along with a sample from a conventional ⅝ inch gypsum board, were evaluated, with the results presented in the graph 1600 of FIG. 16. Here, the data shows that the thinner, more flexible designs based on the inventive composite laminates are more resistant to breaking than conventional building panels. Additionally, a more flexible building panel allows for easier construction and finishing of curved surfaces.

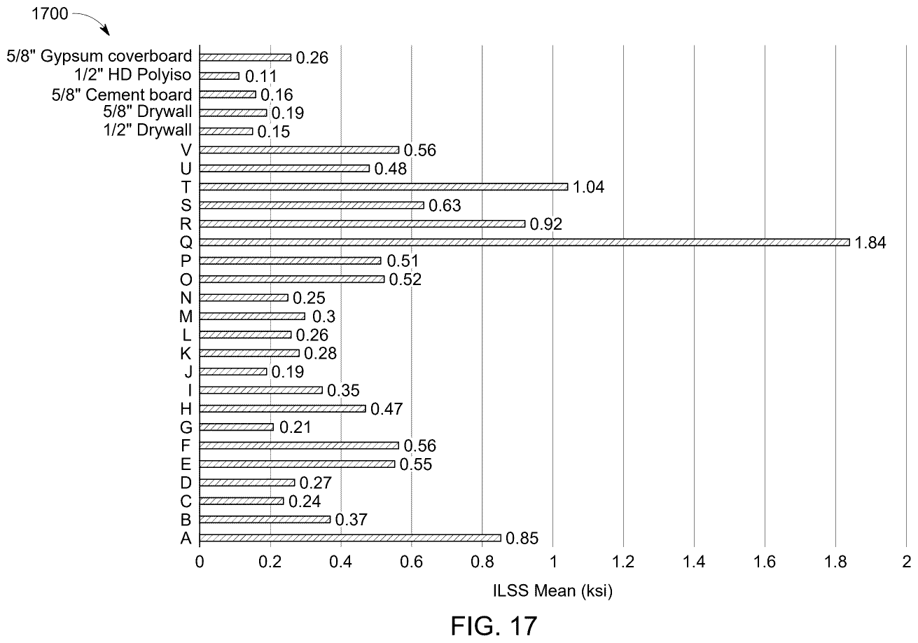

Shear force constitutes a primary failure mode of building panels. Cracks can form in the building panels due to shear failure. Building panels with higher shear strength can resist cracking during installation and/or building settling or shifting. To assess the shear strength of the inventive building panels, samples of the inventive building panels (i.e., Samples A-V) were compared to samples of representative, commercially available building panels (i.e., ⅝ inch gypsum coverboard, ½ inch HD polyiso board, ⅝ inch cement board, ⅝ inch drywall, and ½ inch drywall). All specimens were cut to 0.5 inch×1 inch rectangles, with supports fixed to allow 0.25 inch overhang on each side of the sample. The testing was in accordance with a modified version of the ASTM D2344 standard (short-beam strength test). In particular, as a variation of the standard, the test was performed on samples (i.e., Samples A-V) that each have a fixed length and width of 1 inch×½ inch and thickness of ⅛ inch, while the control samples also had a fixed length and width of 1 inch×½ inch and a thickness of ½ inch or ⅝ inch. The test results are shown in the graph 1700 of FIG. 17. This shows that building panels can be readily constructed to have a particular shear strength as needed (e.g., from 0.19 ksi to 1.84 ksi) by varying the construction of the composite laminate material.

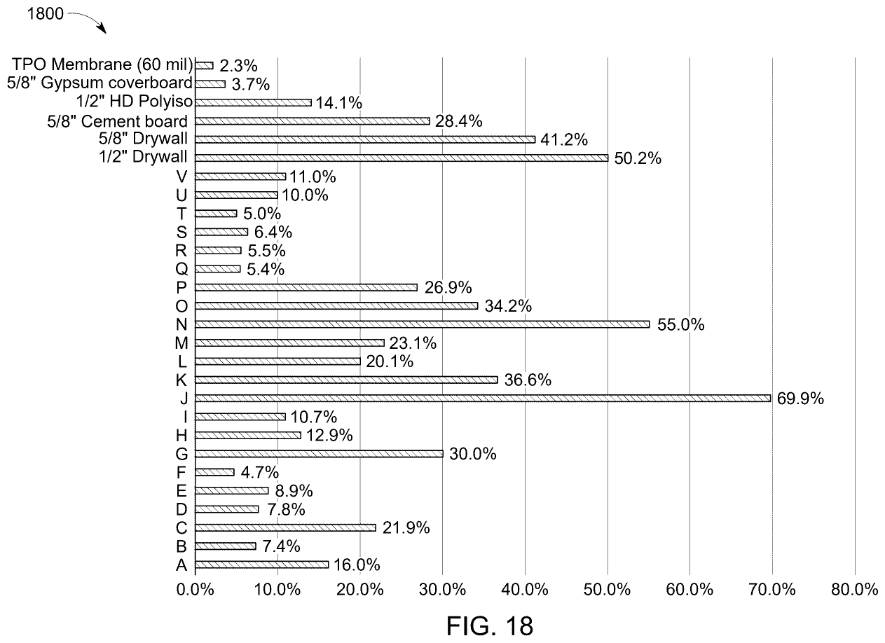

Water absorption in building panels varies significantly depending on the material. Understanding this property is crucial for material selection and moisture management in construction. To assess the water absorption of the inventive building panels, samples of the inventive building panels (i.e., Samples A-V) were compared to samples of representative, commercially available building materials (i.e., 60 mm TPO membrane, ⅝ inch gypsum coverboard, ½ inch HD polyiso board, ⅝ inch cement board tile backer, ⅝ inch drywall, and ½ inch drywall). The testing was in accordance with the ASTM D570 standard (water absorption at 24 hour test). Water absorption is expressed as increase in weight percent, wherein: Percent Water Absorption=[(Wet weight−Dry weight)/Dry weight]×100. The test results are shown in the graph 1800 of FIG. 18. This shows that building panels can be readily constructed to have a particular water absorption limit as needed (e.g., at low as 4.7%) by varying the construction of the composite laminate material.

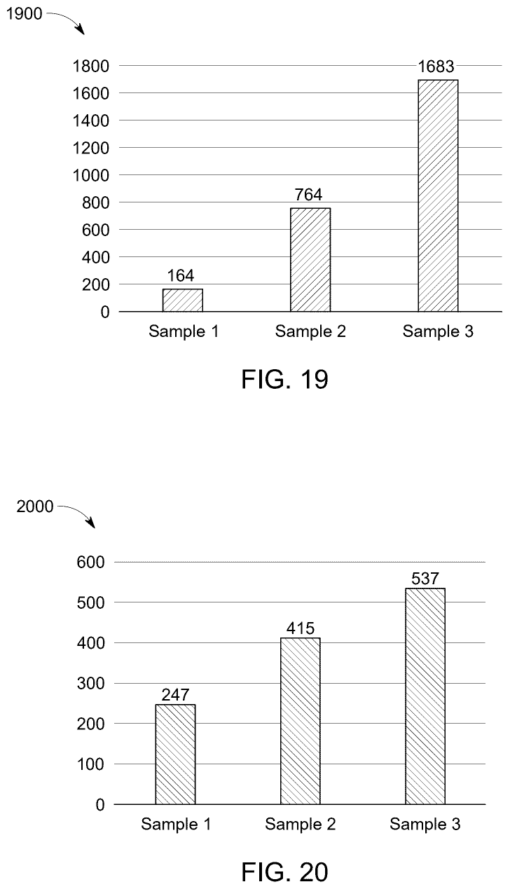

Additionally, testing was carried out to establish the efficacy of the inventive composite laminate material as a facer, such as for a polyiso insulation board. As shown in the graph 1900 of FIG. 19, the impact strength (N) measured according to the ASTM D3763 standard of a conventional 2 inch polyiso insulation board (Sample 1) was improved when adding a 3-ply embodiment of the inventive composite laminate (Sample 2), and was further improved when adding a 4-ply embodiment of the inventive composite laminate (Sample 3).

Likewise, testing further established that fastener pull through was enhanced when the inventive composite laminate material was applied as a facer to a conventional polyiso insulation board. As shown in the graph 2000 of FIG. 20, the force (lbf) required to pull the fastener through a sample from the conventional 2 inch polyiso insulation board (Sample 1) was improved when adding a 3-ply embodiment of the inventive composite laminate (Sample 2), and was further improved when adding a 4-ply embodiment of the inventive composite laminate (Sample 3). This testing was carried out in accordance with a modified version of the ASTM D1761 standard, wherein a 3 inch ribbed galvalume plate and a 4 inch fastener resembling a screw were used.

The scope of the general inventive concepts presented herein are not intended to be limited to the particular exemplary embodiments shown and described herein. From the disclosure given, those skilled in the art will not only understand the general inventive concepts and their attendant advantages, but will also find apparent various changes and modifications to the devices and systems disclosed. Furthermore, unless the context indicates otherwise, the concepts and features disclosed herein are readily combinable. For example, a coverboard, building panel, facing material, or other building product can be fashioned to have one or more of a desired impact strength, fastener retention, fire performance, adhesion strength, shear strength, water absorption, etc. It is sought, therefore, to cover all such changes and modifications as fall within the spirit and scope of the general inventive concepts, as described and/or claimed herein, and any equivalents thereof.

What is claimed is:

1. A composite laminate for use as a coverboard installed above a roof deck, the composite laminate comprising:
a plurality of polymeric sheets, each polymeric sheet defining a layer of the composite laminate and comprising a plurality of reinforcing fibers;
wherein the polymeric sheets include a first polymeric sheet positioned so that the reinforcing fibers of the first polymeric sheet are oriented in a first direction;
wherein the polymeric sheets include a second polymeric sheet positioned so that the reinforcing fibers of the second polymeric sheet are oriented in a second direction; and
wherein the layer defined by the first polymeric sheet is adjacent to the layer defined by the second polymeric sheet.

2. The composite laminate of claim 1, wherein the first direction differs from the second direction by about 85° to about 95°.

3. The composite laminate of claim 1, wherein the first direction is orthogonal to the second direction.

4. The composite laminate of claim 1, wherein at least one of the first polymeric sheet and the second polymeric sheet comprises about 10% to about 90% of a polymeric material and about 90% to about 10% of the reinforcing fibers.

5. The composite laminate of claim 1, wherein the composite laminate comprises from two to ten layers.

6. The composite laminate of claim 1, wherein the composite laminate comprises at least six layers.

7. The composite laminate of claim 1, wherein the composite laminate comprises a plurality of adjacent layers having the reinforcing fibers oriented in the same direction.

8. The composite laminate of claim 1, wherein the composite laminate comprises at least six adjacent layers having the reinforcing fibers oriented in the same direction.

9. The composite laminate of claim 1, wherein the composite laminate is stored as a roll.

10. The composite laminate of claim 9, wherein the roll includes a core.

11. The composite laminate of claim 1, wherein the composite laminate has a width greater than 8 feet.

12. The composite laminate of claim 1, wherein the composite laminate has a length greater than 16 feet.

13. The composite laminate of claim 1, wherein the composite laminate has a length of at least 100 feet.

14. The composite laminate of claim 1, wherein the composite laminate has a thickness of less than ½ inch.

15. The composite laminate of claim 1, wherein the composite laminate has a width greater than 8 feet, a length greater than 50 feet, and a thickness of less than ½ inch.

16. The composite laminate of claim 1, wherein the composite laminate has a weight of less than 2 lbs/ft².

17. The composite laminate of claim 1, wherein a facing material is affixed to at least one face of the composite laminate.

18. The composite laminate of claim 1, wherein the reinforcing fibers are glass fibers.

19. The composite laminate of claim 1, wherein the composite laminate has an impact strength of at least 1,500 N.

20. The composite laminate of claim 1, wherein the composite laminate has a fastener pull through strength of at least 260 lbf.
